(19) United States
(12) Patent Application Publication
(10) Pub. No.: US 2009/0151645 A1
(43) Pub. Date: Jun. 18, 2009

(54) PET WASTE RECEPTACLE

(76) Inventor: Marvel Fangsrud, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/959,304

(22) Filed: Dec. 18, 2007

(51) Int. Cl. A01K 29/00

(52) U.S. Cl. 119/161

(57) ABSTRACT

A sanitary pet waste receptacle for use when walking or otherwise exercising a person's pet. The receptacle preferably includes a plurality of compartments for separately storing plural items, such as empty pet waste containment bags, used pet waste containment bags, disposable hand wipes, and the like.

### CROSS-REFERENCE TO RELATED APPLICATIONS

None.

### BACKGROUND OF THE INVENTION

The present invention relates to a receptacle for storing pet waste.

Many municipalities and other governing entities have ordinances requiring pet owners to collect and dispose of their pet's waste while walking or otherwise exercising the animal. To this end, there are commercial products available to gather and dispose of the pet waste; most prominently small, shovel-like instruments to collect the pet waste and disposable containment bags, usually of a plastic fabrication, within which to insert the collected pet waste. Oftentimes, the shovel-like instrument is not used, as the pet owner may simply insert a hand into the containment bags, pick up the pet waste, and evert the containment bag to thereby contain the pet waste.

While walking or otherwise exercising a pet, disposing of the used containment bag often becomes problematic. It is typically undesirable, for obvious aesthetic reasons, for a pet owner to walk a significant distance, pet waste in hand. Nonetheless, this scenario is often the only feasible alternative, particularly when hiking with a pet over extended distances on wilderness trails. Furthermore, even when exercising a pet in a relatively confined city park, it is not uncommon to be located some distance from an available trash can or other disposal area.

Manual collection of pet waste also presents hygienic concerns. For example, it is recommended that, when enjoying a long hike or backpacking trip, a person carry food/water etc. with which to stay safely hydrated and nourished for the outing. Yet, the earlier, manual collection of pet waste introduces the risk of bacterial contamination when eating or drinking.

What is desired, then, is an improved system for gathering and disposing of pet waste while on outdoor excursions.

### BRIEF DESCRIPTION OF THE DRAWINGS

FIG. 1 shows a perspective view of a pet waste receptacle fabricated in accordance with one aspect of the disclosure herein.

FIG. 2A shows a first alternative cross section of the pet waste receptacle of FIG. 1, taken along line 2-2 of that figure, and showing three interior compartments.

FIG. 2B shows a second alternative cross section of the pet waste receptacle of FIG. 1 taken along line 2-2.

FIG. 3A shows a bottom view of the pet waste receptacle of FIG. 1.

FIG. 3B shows a bottom view of an alternative pet waste receptacle having a removable panel allowing access into the lower compartment.

FIG. 3C shows a cutaway view of the bottom of a second alternative pet waste receptacle showing a hinged bottom wall allowing access into the lower compartment.

FIG. 4A shows a cutaway view of the top of the pet waste receptacle of FIG. 1 having a strap with opposed ends selectively separable from each other.

FIG. 4B shows a cutaway view of the top of the pet waste receptacle of FIG. 1 having a strap with at least one end selectively separable from an outer surface of the pet waste receptacle.

FIG. 5 shows an exemplary leash having a fastener selectively securable to the strap of FIGS. 4A and 4B.

FIGS. 6 and 7 show an alternative pet waste receptacle to that shown in FIG. 1, and having three compartments.

FIG. 8 shows another alternative pet waste receptacle to that shown in FIG. 1.

### DETAILED DESCRIPTION OF PREFERRED EMBODIMENTS

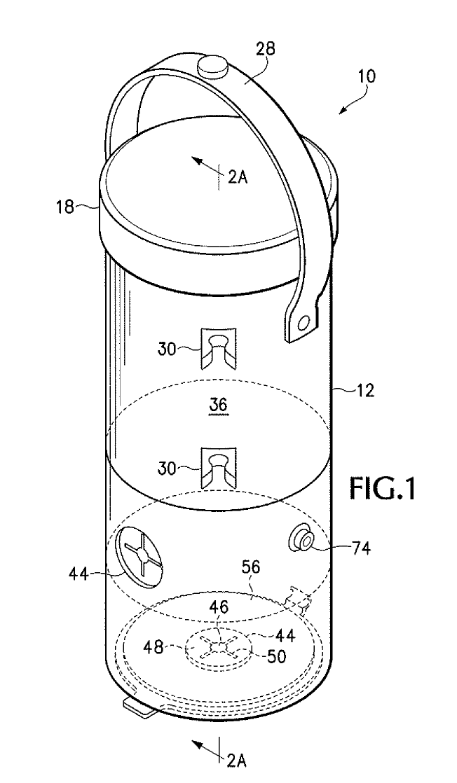

FIGS. 1-3 show exemplary embodiments of a pet waste receptacle 10 having an outer member 12 defining a container 14 to store pet waste (mercifully, not shown). Preferably, the pet waste receptacle includes one or more interior surfaces, such as 16a, 16b, 16c that define a plurality of compartments. For example, the pet waste receptacle 10 may include a first compartment 20, a second compartment 22, and a third compartment 24. The first compartment 20 may be used to dispense empty pet waste containment bags, the second compartment 22 used to store full or used such containment bags, while the third compartment 24 may be used to store sanitary, disposable hand wipes. The hand wipes may preferably be moist and include an antibacterial agent therein. The second compartment 22 may include an open upper boundary 26 to facilitate disposal therein of used containment bags, and hence may optionally include a cover 18 selectively securable around the open upper boundary 26. It should be readily appreciated that the arrangement of the compartments 20, 22, and 24 as just described, or the materials respectively contained therein, may be varied. The pet waste receptacle may also optionally include a strap 28 by which the receptacle 10 can be conveniently carried. Furthermore, the receptacle 10 also preferably includes a plurality of flexible members 30, spaced apart from each other an appropriate distance to permit the secure, detachable affixation of a small scooper or other shovel-like instrument (not shown) to the receptacle 10.

The pet waste receptacle 10 advantageously allows a pet owner to carry, in a convenient and sanitary manner, all the materials necessary to hygienically allow the collection and disposal of pet waste. For example, when collecting pet waste, an owner may retrieve a containment bag from the compartment 20 and, once full, deposit the containment bag into the compartment 22, which is structurally separated from the compartment 20 by a wall 23 so that full containment bags do not contaminate empty bags. Thereafter, the pet owner may retrieve a disposable hand wipe from the compartment 24 to cleanse the owner's hands, again depositing the used hand wipe in the compartment 22 when finished. The compartment 22 may optionally include a cover 18 to seal the compartment 22.

The pet waste receptacle 10 may be fashioned of any appropriate material, such as plastic, tin, aluminum, etc. using any manufacturing process appropriate for the material, e.g. molding, extrusion, press-rolling etc. Preferably, the pet waste receptacle 10 is made from a lightweight material, and has a sufficiently small size so as to be carried by hand, or as later described in more detail, on a pet leash. Pet waste receptacles 10 may be made in a variety of sizes and weights so as to accommodate pets of different sizes and species. Although the various embodiments of the pet waste receptacles 10 shown in the present disclosure are generally tubular in shape, the pet waste receptacle 10 may be shaped in any appropriate geometrical configuration, such as a cube, a cylinder of any desired cross section (e.g. rectangular, triangular), etc.

The compartment 22 preferably defines an enclosure having an open upper boundary 26 sized sufficiently to permit the insertion of full disposal bags, as well as interior dimensions sized sufficiently to permit the containment of full disposal bags. The cover 18 may be sized to securely slide over the receptacle 10, covering the open boundary 26, may be threaded to screw onto the receptacle 10, or be designed in any other appropriate manner to be secured to the receptacle 10, e.g. a tethering strap, snap fasteners, etc. If the receptacle 10 includes a threaded cover 18 or other such lid to selectively seal the compartment 22, an exterior surface 36 of the outer member 12 may be threaded in the region proximate the open boundary of the compartment 22.

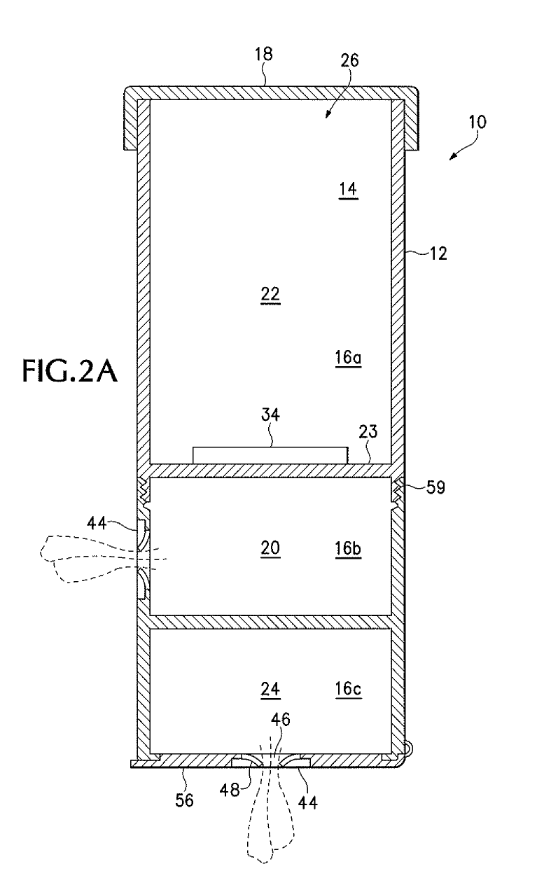

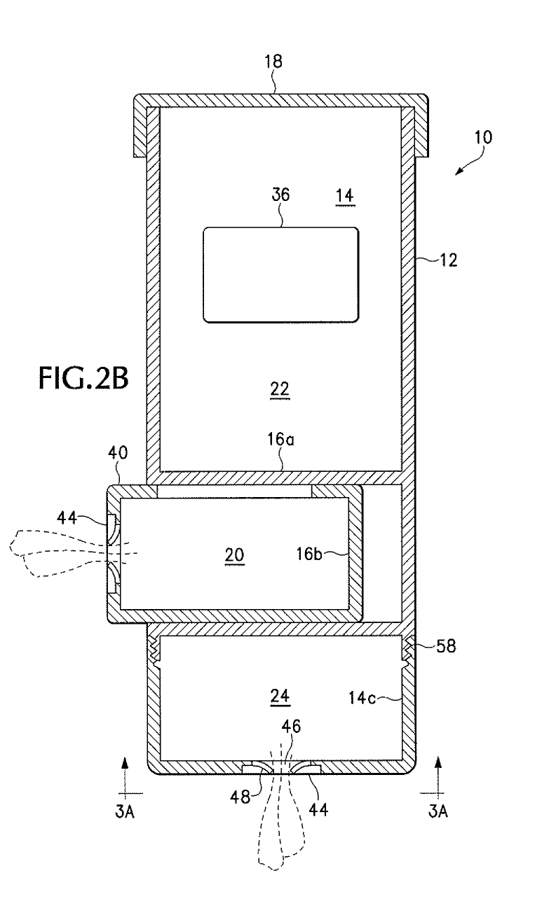

If desired, the compartment 22 may include a deodorant material 34 inserted therein. The deodorant material 34 may simply be located on the bottom surface of the compartment 22 (as shown in FIG. 2A), or alternatively, may be inserted into a pocket 36 formed in an interior wall of the compartment 22 (as shown in FIG. 2B).

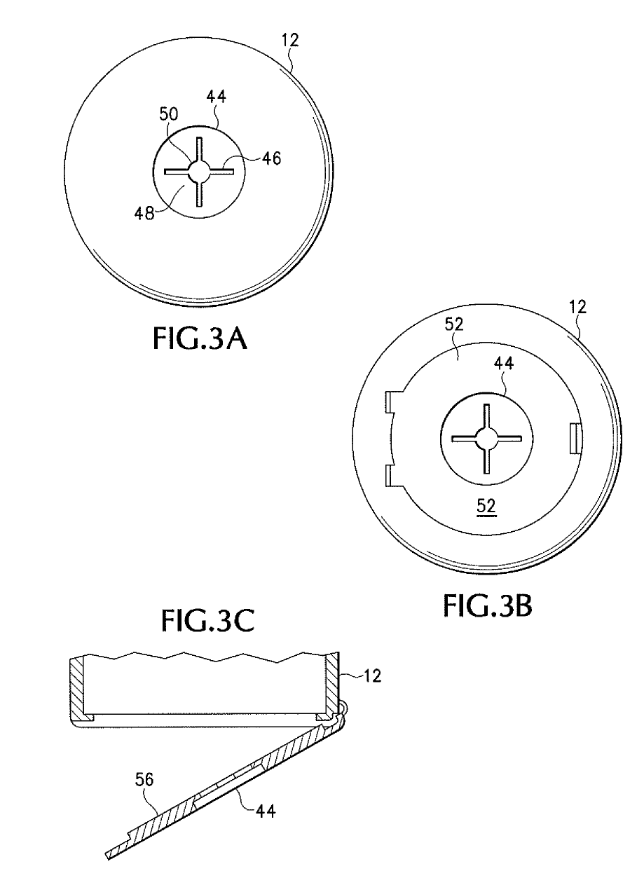

Referring specifically to FIGS. 2A-2B, which each show respective alternative embodiments of receptacle 10, and 3A-3C, which likewise each show respective alternative embodiments of a bottom portion of the receptacle 10, the receptacle 10 may include a compartment 20 to store empty containment bags and a compartment 24 to store disposable hand wipes. The compartments 20 and 24 may be fashioned in any appropriate manner to facilitate the insertion and removal of these components. With respect to the insertion and removal of the disposable hand wipes, for example, the receptacle 10 may include a dispenser 44, at the bottom surface of the receptacle 10, comprising an opening 46 defined by a flexible material 48 having a plurality of slits or cuts 50 extending away from a central region of the opening 46 in a radial manner. The flexible material 48 may be plastic, rubber, or any other suitable material having a minimum flexibility sufficient to permit the opening 46 to expand and contract a sufficient amount to remove empty containment bags. Where such a dispenser 44 is used for the individual removal of containment bags, insertion of a plurality of such bags may be accomplished through a removable cover 52 surrounding the dispenser 42, such as the one shown in FIG. 3B, similar to those commonly found to seal battery compartments in consumer electronic devices. Alternatively, as shown in FIG. 3C, the receptacle 10 may include a hinged, swinging bottom cover 56 to permit access into the compartment 24 or a threaded connection 58 as shown in FIG. 2A to permit the compartment 24 to be unscrewed from the remainder of the receptacle 10. These examples of access mechanisms are illustrative only, as those skilled in the art may devise other mechanisms o substitute for those described herein.

With respect to the insertion and removal of the empty containment bags, the pet waste receptacle 10 may incorporate any one of a number of structural features designed to allow access to the compartment 20. For example, FIG. 2A shows that the compartment 20 may be accessed using a threaded connection 59 so as to fill the compartment 20 with empty containment bags. This threaded connection may also be used to remove individual empty bags for use, or if desired a dispenser 44 may be formed in the outer surface of the receptacle 10 proximate the compartment 20. In an alternative embodiment as illustrated in FIG. 2B, the receptacle 10 may include a sliding tray 40 that slides into and out of the compartment 20, or more simply, may merely substitute a door for the depicted sliding tray 40. Again, the sliding tray or door may be used to both insert and remove containment bags, or if desired, a dispenser 44 may be formed in the tray, door, or other portion of the boundary surrounding the compartment 20. Furthermore, if a sliding tray 40 is used, it may be desirable to fashion disposable cartridges of empty containment bags inserted in bulk through the sliding tray and removable individually through the dispenser 44, which may be formed as part of the cartridge, or alternatively as part of the outer boundary of the receptacle 10. In that latter instance, the cartridge may simply include an opening to align with the dispenser 44.

It should be understood that, although the foregoing features of a pet waste receptacle were illustrated using particular descriptive embodiments shown in the figures, various permutations of these features may be selected to fashion other embodiments of the disclosed pet waste receptacle 10. Preferably, however, the particular mechanisms used to permit access to the compartments 20 and 24 should be complimentary. For example, if a threaded connection is used to detachably connect the compartment 20 and the compartment 22 above, then a door 52 shown in FIG. 3B may be used, so as to avoid an unwieldy construction having dual threaded connections into both the compartment 20 and 24. Alternatively, if a threaded connection is used to detachably connect the compartment 24 and the compartment 20 above, then a tray 40 or a door similar to 52 but surrounding the dispenser 42 may be used.

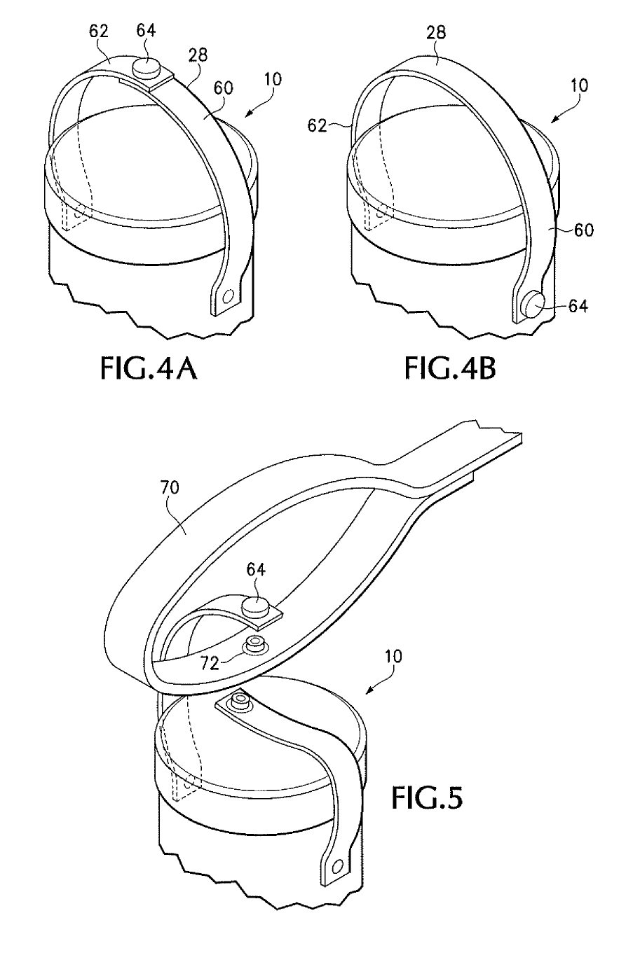

Referring to FIGS. 4A-4B, the receptacle 10 may include a strap 28 to carry the receptacle 10. Preferably, the strap 28 is affixed to the exterior surface of the receptacle 10 at both ends 60 and 62 of the strap. In one embodiment, shown in FIG. 4B, the strap 28 is detachably fixed at the end 60 through a fastener 64 comprising male and female snap connections, or other suitable connection, such as a loop/button arrangement. When detached from the receptacle 10, the strap 28 may be affixed to a pet leash 70 (shown in FIG. 5) using, e.g. a snap connection 72 corresponding to the one affixed to the exterior surface of the receptacle 10. Stated otherwise, the exterior surface of the receptacle 10 may include one half of a fastener 64, such as a male snap connection to which a female snap connection is selectively snapped (or vice versa), or alternatively, a loop through which a button is fastened, etc. A duplicate of the fastener that is affixed to the exterior surface of the receptacle 10 may also be included on a pet leash. The other, mating half of the fastener is included on the end 60 of the strap, such that that end may be selectively attached to either the receptacle 10, to facilitate the owner carrying the receptacle by hand, or alternatively, connected to a pet leash.

In the arrangement described in the preceding paragraph, if the strap 28 is too short, it may be unwieldy to carry the receptacle 10 by hand, but the short strap does permit a leash to carry the receptacle 10 without dragging it on the ground. Alternatively, if the strap is too long, such that it is easy to carry the receptacle 10 by hand, the receptacle may drag on the ground when carried by a pet. Referring to FIG. 4A, an alternative arrangement affixes the strap 28 at either end to the receptacle 10, and a snap connection 64 or other such fastener is included towards the middle of the strap, distant from either end. When disconnected, one end of the strap may be secured to a pet leash, while the other end may preferably be secured to a fastener 74 (shown in FIG. 1) attached to a lateral exterior surface of the receptacle 10, so that it is not free to flail about.

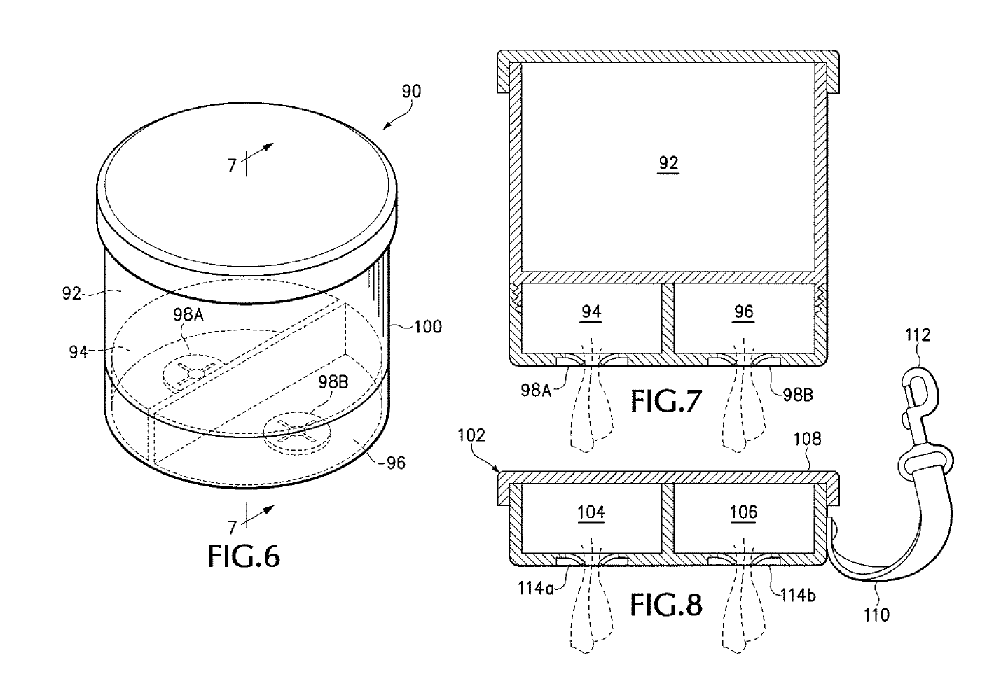

FIGS. 6 and 7 show an alternative pet waste receptacle 90 having an upper compartment 92 to store used containment bags and two adjacent lower compartments 94 and 96 to store empty containment bags and hand wipes, respectively. Each of the compartments 94 and 96 may include a separate dispenser 98A and 98B, respectively, and the compartments 94 and 96 may be detachably secured to the compartment 92 via a threaded connection 100.

Referring to FIG. 8, another alternative pet waste receptacle 102 is depicted having a first compartment 104 for storing empty containment bags and a second compartment 106 or storing wet wipes. The pet waste receptacle may preferably be cylindrical or rectangular in shape, however it should be understood that other geometrical shapes are feasible. The pet waste receptacle 102 is preferably compact, measuring less than 8 inches in width or diameter and less than 4 inches in height. More preferably, the pet waste receptacle 102 measures less than 6 inches in width (diameter) and 3 inches in height. Preferably, each compartment 104 and 106 includes a dispenser, such as 140a, 140b so as to remove individual respective wet wipes and empty containment bags. The pet waste receptacle 102 may includes a strap 110 having at its distal end a fastener 112 comprising the hook and retractable pin arrangement typically seen on pet leashes, for example. The fastener 10 may be sized appropriately so as to be easily secured to the handle section of a pet leash.

It should be understood that the foregoing embodiments of the disclosed pet waste receptacle, such as the receptacles 10 and 90 are illustrative only, and receptacles of other configurations may easily be designed. For example, a pet waste receptacle constructed in conformance with the foregoing disclosure may only include a compartment for storing used containment bags and a compartment for storing, alternatively, either disposable wet wipes or empty containment bags. Furthermore, a pet waste receptacle constructed in conformance with the foregoing disclosure may include more than three compartments for storing other items, or may include additional fasteners on the exterior surface for securing key rings, etc.

The terms and expressions that have been employed in the foregoing specification are used therein as terms of description and not of limitation, and there is no intention, in the use of such terms and expressions, of excluding equivalents of the features shown and described, or portions thereof. Furthermore, those skilled in the art will appreciate that the structures described herein can be implemented in many different variations, and although exemplary embodiments are specifically illustrated herein, it should be understood that modifications and variations of the exemplary rail car 10 may be employed; thus, the scope of any inventions individually claimed are respectively defined and limited only by the terms of the respective claims that follow.

1. A sanitary pet waste receptacle comprising:
(a) an outer member defining a container having an exterior surface;
(b) a first compartment defined by an interior surface of said container, said first compartment having a first dispenser for individually dispensing pet waste containment bags;
(c) a second compartment defined by an interior surface of said container and having an open boundary sufficiently sized to selectively receive used said pet waste containment bags, said second compartment isolated from said first compartment; and
(d) a third compartment defined by an interior surface of said container and having a second dispenser suitable for dispensing disposable hand wipes, said third compartment isolated from said second compartment.

2. The sanitary pet waste receptacle of claim 1 where said third compartment is isolated from said first compartment.

3. The sanitary pet waste receptacle of claim 1 including a cap selectively securable to said outer member over said open boundary.

4. The sanitary pet waste receptacle of claim 1 where said third compartment is detachably secured to said pet waste receptacle.

5. The sanitary pet waste receptacle of claim 4 where said third compartment matingly receives a refill cartridge of said disposable hand wipes.

6. The sanitary pet waste receptacle of claim 1 where said second dispenser is an opening defined by a flexible material with a plurality of slits radially extending outward from a common region.

7. The sanitary pet waste receptacle of claim 1 where said first compartment is detachably secured to said pet waste receptacle.

8. The sanitary pet waste receptacle of claim 1 where said pet waste receptacle includes a length and said first compartment is slidably engaged with said pet waste receptacle in a lateral direction with respect to said length.

9. The sanitary pet waste receptacle of claim 1 where said first compartment includes a door to facilitate insertion of said containment bags.

10. The sanitary pet waste receptacle of claim 1 including a pocket in said second compartment capable of selectively receiving a deodorant material.

11. The sanitary pet waste receptacle of claim 1 where said container is elongate and said first compartment separates said second and third compartments.

12. The sanitary pet waste receptacle of claim 1 where said container includes a first divider isolating said first compartment from said third compartment and a second divider isolating said second compartment from said first compartment and said third compartment, said first divider being oriented substantially perpendicular to said second divider.

13. The sanitary pet waste receptacle of claim 12 where said first dispenser and said second dispenser each comprise a respective opening defined by a flexible material with a plurality of slits extending radially outward from a common region of said respective opening.

14. The sanitary pet waste receptacle of claim 1 including a strap for carrying said container, said strap being secured to said exterior surface at respective first and second ends of said strap.

15. The sanitary pet waste receptacle of claim 14 where said strap includes a fastener for selectively detaching said first end from said second end, said fastener comprising a first fastening member selectively engageable with a second fastening member.

16. The sanitary pet waste receptacle of claim 15 including a duplicate second fastening member affixed to said exterior surface.

17. The sanitary pet waste receptacle of claim 16 where at least one of said first ends and said second ends is detachably secured to said exterior surface by a fastener comprising a first fastening member affixed to said strap and a second fastening member secured to said exterior surface.

18. A sanitary pet waste receptacle having an exterior surface and comprising:
(a) a first compartment defined by an interior surface of said receptacle and having an open boundary sufficiently sized to selectively receive used pet waste containment bags;
(b) a second compartment, said second compartment isolated from said first compartment;
(c) a strap for carrying said container, said strap being secured to said exterior surface at respective first and second ends of said strap; and
(d) a fastening member affixed to said exterior surface, said fastening member being matingly engageable with a second fastening member affixed to said strap at a location spaced apart from each of said first and second ends.

19. In combination with a pet leash having a gripping portion, a first fastener selectively securable to a pet collar, a strap extending between said gripping portion and said first fastener, and a second fastener on said strap at a location spaced apart from said gripping portion, a sanitary pet waste receptacle having an exterior surface and comprising:
(a) a first compartment defined by an interior surface of said receptacle and having an open boundary sufficiently sized to selectively receive used pet waste containment bags;
(b) a second compartment, said second compartment isolated from said first compartment;
(c) a strap for carrying said container, said strap being secured to said exterior surface at respective first and second ends of said strap; and
(d) a strap fastener affixed to said strap and matingly engageable with said second fastener of said pet leash.
